(19) United States
(12) Patent Application Publication
(10) Pub. No.: US 2023/0342781 A1
(43) Pub. Date: Oct. 26, 2023

(54) SYSTEM AND METHOD FOR IDENTITY VERIFICATION

(71) Applicant: Sora ID, Inc., New York, NY (US)

(72) Inventors: Matthew Deutsch, New York, NY (US); Ethan Shen, New York, NY (US); Vamsi Varanasi, New York, NY (US); Cole Winstanley, New York, NY (US); Henry Xu, New York, NY (US)

(21) Appl. No.: 18/298,693

(22) Filed: Apr. 11, 2023

Related U.S. Application Data
(60) Provisional application No. 63/334,550, filed on Apr. 25, 2022.

(51) Int. Cl. G06Q 20/40

(52) U.S. Cl. CPC G06Q 20/40145; G06Q 20/4016

(57) ABSTRACT

In variants, a method for identify verification can include: receiving a request, determining a specification, determining a set of trait instances for a user, and verifying the user according to the specification. However, the method can additionally or alternatively include any other suitable elements.

### CROSS-REFERENCE TO RELATED APPLICATIONS

This application claims the benefit of U.S. Provisional Application No. 63/334,550 filed 25 Apr. 2022, which is incorporated in its entirety by this reference.

### TECHNICAL FIELD

This invention relates generally to the compliance and/or fraud prevention field, and more specifically to a new and useful identity verification system and/or method in the compliance and/or fraud prevention field.

### BACKGROUND

Many entities, such as financial institutions, verify identities of their customers for different reasons, with different standards, using different pieces of data. In order to comply with regulations, a financial institution is required to define its own customer identification process (e.g., customer identification program), and cannot rely on another financial institution's validation using the other financial institution's customer identification process. This leads to inefficiencies in identity verification, since the same basic checks and/or identity information retrieval are oftentimes performed for a given individual by different financial institutions.

Additionally, the current paradigm puts users at an increased risk of identity theft, since each financial institution is individually retrieving the user's data for verification. This exposes each user to the weaknesses of each financial institution's security systems.

Thus, there is a need in the compliance field to create an improved/new and useful identity verification system and/or method.

### BRIEF DESCRIPTION OF THE FIGURES

FIG. 1 is a flowchart representation of a variant of the method.

FIG. 2 is an illustrative example of determining a set of trait instances for a user.

FIG. 3 is an illustrative example of verifying the user based on the specification and the set of trait instances.

FIG. 4 is an illustrative example of determining an external-level check value.

FIG. 5 is an illustrative example of determining a specification value.

FIG. 6 is an illustrative example of repeating S410-S430 for the successive evaluation level.

FIG. 7 is a schematic representation of an example of generating internal-level checks and optionally external-level checks based on a specification.

FIG. 8 is a schematic representation of an example of evaluating a set of specifications using trait instances for one or more users.

FIG. 9 is an illustrative example of specifications associated with the same entity.

FIG. 10 is an illustrative example of determining a new specification based on a template.

FIG. 11 is an illustrative example of evaluation levels for a specification.

FIG. 12 is an illustrative example customizing a theme for the user interface.

FIG. 13 is an illustrative example of determining external-level checks associated with a device for the user.

FIG. 14 is an illustrative example of determining external-level checks associated with personally identifiable information for the user.

FIG. 15 is an illustrative example of determining external-level checks associated with document capture for the user.

FIG. 16 is an illustrative example of determining external-level checks associated with liveness for the user.

FIG. 17 is a first illustrative example of a specification.

FIG. 18A-18E is a second illustrative example of a specification.

FIG. 19A-19C is a third illustrative example of a specification.

FIG. 20 is an illustrative example of determining a manual specification value.

FIG. 21 is an illustrative example of reusing internal-level checks/check values for a user.

FIG. 22 is an illustrative example of retrieving internal-level checks/check values for a user from a database and determining a specification value for a specification based on the internal-level checks/check values.

FIG. 23 is a schematic example of a variant of the system.

### DETAILED DESCRIPTION

The following description of embodiments of the invention is not intended to limit the invention to these embodiments, but rather to enable any person skilled in the art to make and use this invention.

### 1. Overview

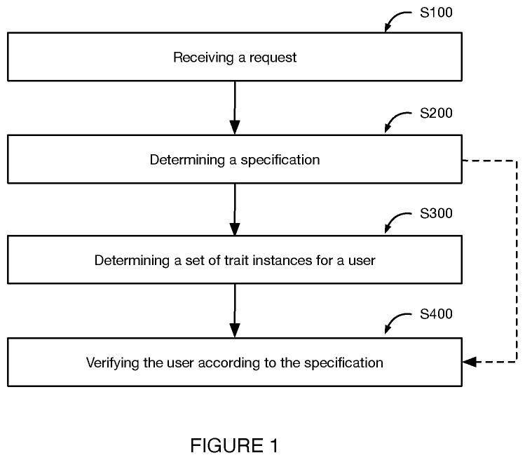

As shown in FIG. 1, the method for identity verification can include: receiving a request S100, determining a specification S200, determining a set of trait instances for a user S300, and verifying the user according to the specification S400.

However, the method can additionally and/or alternatively include any other suitable elements.

The method functions to verify the identity of a user for an entity by determining check values using an entity-specific specification and a set of trait instances for the user; and optionally verify the identity of the same user for a different entity using a different entity-specific specification and (reusing) the determined check values and/or set of trait instances. However, the method can provide any other suitable function.

### 2. Examples

In a first illustrative example, the method can include: receiving a verification request from an entity (e.g., a financial institution) for a user (e.g., the entity's customer); determining a specification (e.g., a customer identification program) for the entity, wherein the specification includes a set of trait evaluations; for each trait to be evaluated, optionally determining any required trait parameter values from the specification (e.g., required data sources that the trait must be pulled from, trait instance recency requirements, etc.); optionally determining a trait instance for the user satisfying the trait parameter values for each trait (e.g., a trait instance for the user originally obtained from the required data source), wherein the trait instance is retrieved from a database and/or an external source (e.g., a third-party, the user, etc.); and evaluating the trait instances according to the specification. A specification can include one or more evaluation levels, each including evaluation logic and one or more layers of one or more external-level checks (e.g., bundled checks, intermediate checks, etc.) and/or internal-level checks (e.g., basic checks), wherein each external-level check can itself include evaluation logic and one or more internal-level checks. Each internal-level check can include a set of traits and evaluation logic for how to evaluate the traits within the set. Evaluating the trait instances can include: determining an internal-level check value for each internal-level check (e.g., for a given evaluation level); optionally determining an external-level check value for each external-level check; optionally determining an evaluation result for the evaluation level; when the evaluation level result is associated with a successive evaluation level, optionally repeating the previous steps for the successive evaluation level; and determining a specification value (e.g., validated, pass, not validated, fail, manual review, etc.) based on the evaluation level results for the user. The retrieved trait instances, the internal-level check values, and optionally the external-level check values can be saved for the user, and optionally reused when evaluating other specifications.

In a second illustrative example, the system can include a set of pre-verified trait instances and/or check results for each of a set of users, wherein the same pre-verified trait instances can be reused in different entity specifications to verify the same user for different entities. In variants, the pre-verified trait instances can expire (e.g., automatically, conditionally, etc.), and the system can re-verify the trait instances for the user independently from specification verification or evaluation.

However, a user's identity can be otherwise verified.

### 3. Technical Advantages

Variants of the technology can confer several benefits over the conventional identity paradigm.

First, variants of the technology enable a user's information, and, in variants, a user's sub-verification results (e.g., bundled “check results”) to be reused for different institutions' identity verifications. This increases the efficiency and speed of identity verification, since the verifying system no longer needs to repeatedly retrieve the same user data from a third-party data provider and thereby no longer needs to wait for a response from the third-party data provider. This can also save energy and decrease Internet network traffic, since the system uses less third-party data provider calls than conventional systems. In examples, this can be accomplished by splitting the corpus of a user's data into individual traits, performing atomic checks (e.g., internal-level checks or validations) using individual instances of the user's traits, and/or persistently storing the user's trait instances and associated check results for future reuse.

Second, variants of the technology enable customizability of identity verification workflows. In variants, the user's sub-verification results (e.g., check values) are stored at a granular level to be reused. This enables the entity to define and customize the customer identification process (e.g., specification) without using preset workflows. Variants of the technology can also enable customers to define higher-order analyses (e.g., external checks, evaluation levels, etc.), which can function to abstract away from lower-level verification implementation. This can create a facile product that is easier to use.

Third, variants of the technology can provide a unified user identity (e.g., “portable identity”), associated with the user's trait instances and/or check results. This enables the user to use a single identity (e.g., single login) for verification—and optionally, authorization (e.g., Oauth)—across multiple services. Additionally, a unified system allows the user's sensitive data to be retrieved, stored, and processed by centralized system, thereby minimizing the user's exposure to financial institutions' security risks (e.g., user's data being exposed in a breach) and financial institutions' exposure to the user's sensitive data (e.g., thereby reducing data security liability). In an illustrative example, financial institutions no longer need to retrieve sensitive user data, and can receive only the results of the overall verification and/or checks.

Fourth, this unified identity can also give users more provenance over their data. For example, instead of contacting each financial institution to update or remove a piece of data, the user can update or remove the data from the centralized system, which then propagates the effects of the change (e.g., verification invalidation, check invalidation, etc.) to the relevant institutions.

Fifth, variants of the technology can enable low- or no-code specification creation. For example, an entity user can use a graphical user interface to assemble the specification using a set of graphical icons, dropdown menus, connections, and/or other graphical components representative of traits, checks (e.g. logic), outcomes, and/or other specification components.

However, the technology can confer any other suitable benefits.

### 4. System

The method is preferably performed by using a system 10 (example shown in FIG. 23), including: one or more computing systems 110, one or more identity verification systems 120, optionally one or more interfaces 130, optionally one or more databases 140, and/or any other suitable components. However, the method can additionally and/or alternatively be performed using any other suitable system.

The system 10 functions to verify the identity of a user for an entity based on an entity-specific specification and user-specific trait instances.

The system 10 and/or method can be used with one or more entities. Each entity preferably requires identity verification (e.g., for AML/KYC, for fraud detection/prevention, etc.), but can additionally and/or alternatively require trusted login, access to sensitive user data, and/or any other suitable requirements. Different entities preferably have different identity verification processes, but can additionally and/or alternatively have the same identity verification process. Examples of entities that can use the technology include: financial institutions (e.g., credit card companies, banks, crypto, etc.), insurance companies, digital health companies, human resource management company, networking platform company, and/or any other suitable organization, individual, and/or any other suitable entity. The system 10 preferably interfaces with a plurality of entities, but can additionally and/or alternatively interface with a single entity.

The system 10 and/or method can be used with one or more users. Users are preferably customers (e.g., prospective customer, current customer, previous customer, etc.) of the one or more entities, but can additionally and/or alternatively not be affiliated with an entity, and/or be any other suitable individual. Each user can be a customer for: one entity, multiple entities, and/or any other suitable number of entities. Each user's identity is preferably verified (e.g., prior to using the entity's product and/or service) using different identity verification processes for different entities, but can additionally and/or alternatively be verified using the same identity verification process for different entities. Each user is preferably associated with a user identifier, but can additionally and/or alternatively not be associated with a user identifier. The user identifier can include: platform login credentials (e.g., username, password, etc.), a user access token, biometrics, one-time passwords (OTPs), HMAC-based one-time passwords (HOTPs), time-based one-time passwords (TOTPs), one or more pieces of identifying information (e.g., name, last four digits of SSN, phone number, email address, biometrics, etc.), combinations thereof, and/or any other suitable information. The user identifier can be a primary user identifier or a non-primary user identifier. For example, a primary user identifier includes an email address or a phone number.

The system 10 and/or method can be used with one or more third-parties. Third-parties preferably provide identity data (e.g., trait instances) of users, but can additionally and/or alternatively store identity data of users, verify identities of users, and/or have any other suitable function. Third-parties are preferably data providers (e.g., Experian™, Equifax™, TransUnion™, etc.), but can additionally and/or alternatively be credit bureaus, real estate listing services, government agencies, business partners, and/or any other suitable party. The system 10 preferably interfaces with a plurality of data providers, but can additionally and/or alternatively interface with a single data provider. The system 10 preferably requests user data from the third-parties (e.g., using an API request, an API call, etc.) but can receive data pushed by the third-party, and/or otherwise receive user data. The requests and/or responses can be: signed (e.g., by a key issued by the third-party data provider, issued by the system, issued by the user, etc.), encrypted (e.g., with a symmetric and/or asymmetric keypair), and/or otherwise secured.

The system 10 and/or method can be used with one or more: traits, trait instances, checks, and/or any other suitable data objects.

Traits function to define attributes related to the identity of a user to be verified. Each trait is preferably represented as a data type (e.g., primitive data types, non-primitive data types), but can alternatively not be represented as a data type. Data types can include: string, array, list, class, boolean, double, char, float, long, int, short, byte, and/or any other suitable data type. Traits can include: name (e.g., first name, last name, middle name, middle initial, full name, etc.), address (e.g., personal address, business address, street, zip code, city, state, province, country, etc.), phone (e.g., cell number, home number, work number, etc.), email address, SSN, ITIN, birthdate, place of birth, photo (e.g., of a selfie, extracted from a documentation, etc.), age, gender, sex, height, weight, eye color, hair color, credit score, IP address, location, device, documents (e.g., government ID, driver's license, passport, etc.), biometrics (e.g., fingerprints, iris patterns, facial features, voice, etc.), sanctions list (e.g., OFAC sanctions list), politically exposed persons (PEP) list, and/or any other suitable attribute. Traits are preferably associated with trait values and trait parameters, but can alternatively not be associated with trait parameters. Trait parameters can include: a trait identifier, trait value (e.g., the user's value for the trait), source (e.g., the data source from which the trait value was received, such as DMV, credit bureau, user, etc.), creation time and/or timestamp (e.g., trait value retrieval time, manual trait value entry time, etc.), validity time and/or timestamp and/or duration, automatic expiration time and/or timestamp, validity state (e.g., valid or invalid), value receipt metadata (e.g., the IMEI or model of the user device used to enter the value, user geolocation, user IP address, etc.), and/or any other suitable parameters. Trait parameter values can be the value for the trait parameter for the trait. For example, the value for a trait identifier can be a hash of a user identifier, the value for the source can be the third-party data provider identifier, the value for the creation time can be the wall clock time at which the trait was created, and/or otherwise defined. Traits are preferably not associated with any trait parameter values by default, but can alternatively be associated with values for one or more trait parameters, and/or otherwise associated with trait parameter values.

However, traits can be otherwise configured.

A trait instance (e.g., datum of user information) can be a unique combination of trait parameter values, a single instance of a trait value, or be otherwise defined. A user can be associated with multiple trait instances for a given trait, where each trait instance can vary by one or more trait parameter values. For example, a user can have multiple address instances, each received from a different source (e.g., DMV, user, real estate listing services, credit bureau, etc.) and/or determined at a different time (e.g., different timestamps).

Trait instances can be created upon data retrieval, created upon data receipt, created upon execution of a specification that uses the trait, created periodically (e.g., trait values are periodically updated for a user), created upon initial user registration with the platform, created when a prior instance of the trait is invalidated, and/or otherwise created.

A different trait instance is preferably created each time a new trait value for a given trait is received; alternatively, a prior trait instance can be updated with the new trait value and accompanying trait parameter values. The trait value of a trait instance can be received from: the user, a data provider (e.g., third-party data provider via an API), be synthetically generated (e.g., using a voting mechanism, etc.), extracted from other data (e.g., images, documents, etc.), and/or otherwise determined. The resultant trait instance can include: the source identifier, the receipt time and/or timestamp, and/or any other suitable trait parameter value.

In variants, trait instances can be invalidated. In a first example, the trait instance can be invalidated when a new, different trait value that conflicts with the prior trait value is received or verified as true (e.g., when a threshold number of internal checks confirm the trait value). In a second example, the trait instance can be invalidated and/or removed from the platform (e.g., from the database) when an automatic expiration time and/or timestamp has passed. Different trait instances can have different expiration duration (e.g., determined based on the trait type, the data source, other trait parameter, etc.), and/or have the same expiration duration. In a third example, the trait instance can be invalidated when a new trait instance (e.g., with a more recent timestamp) is retrieved and/or received from the same source as the previous trait instance (e.g., for the same trait). When a trait instance is invalidated, the new trait instance can replace the previous trait instance in a database 140. When a trait instance is invalidated, the trait instance can be stored (e.g., with an invalid state), removed, archived, or otherwise managed. Trait instances can additionally or alternatively be converted into a standard format, stored (e.g., in a database 140), removed (e.g., from a database 140, and/or otherwise managed.

Trait instances can optionally be associated with check values for a set of checks.

However, trait instances can be otherwise configured.

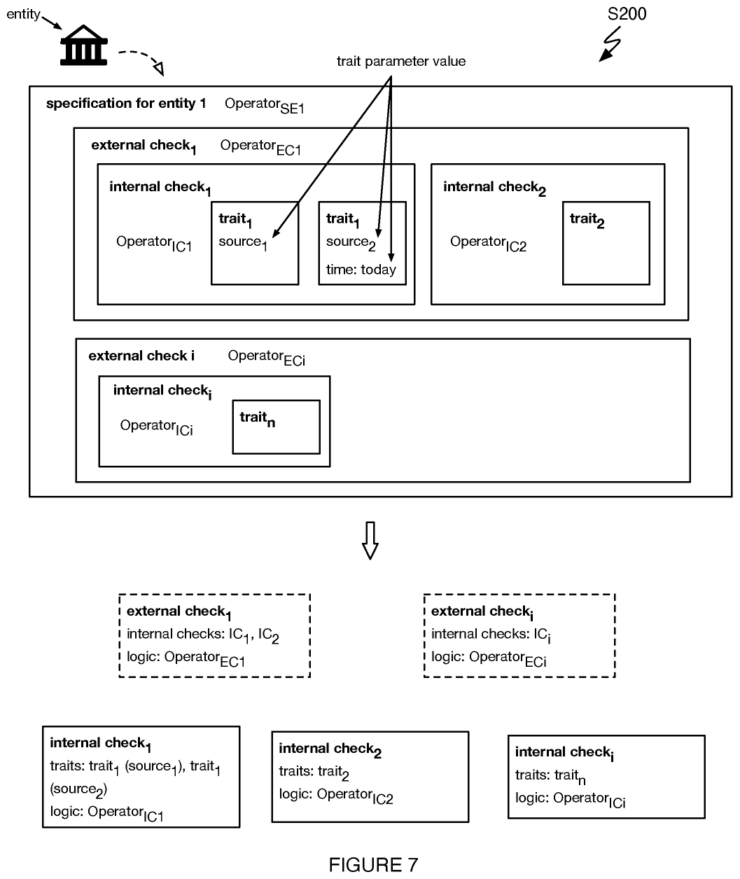

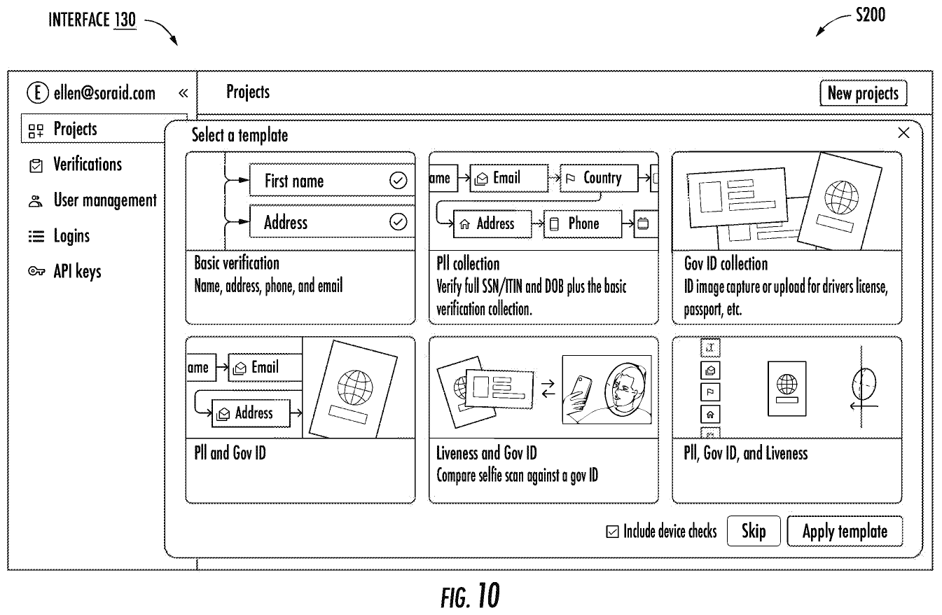

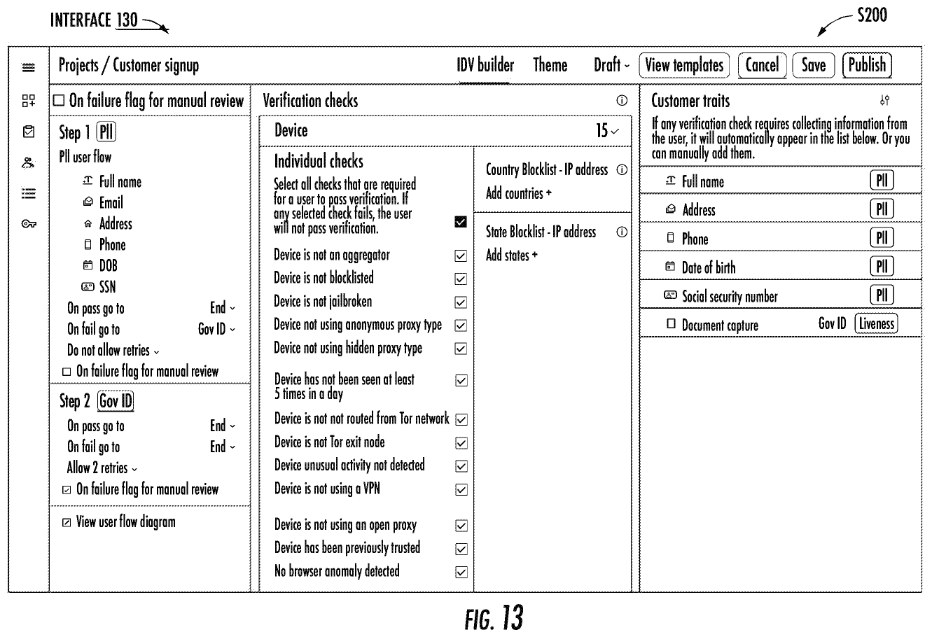

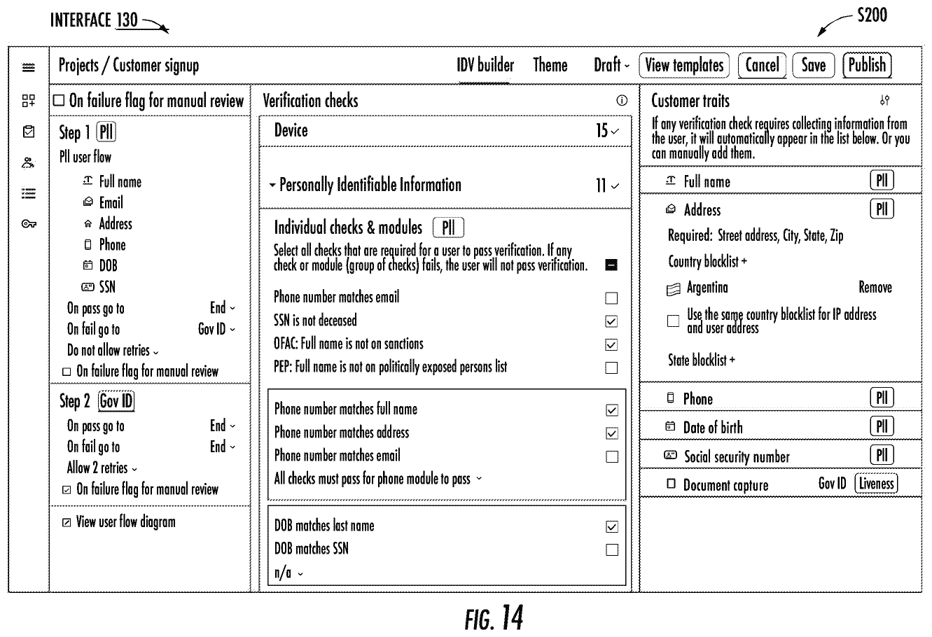

Checks function to evaluate the trait instances according to a set of operators (e.g., logic), and generate check values. Checks can be defined by the platform, defined by an entity (e.g., accessible to only the authoring entity, accessible to any entity, etc.) or a specification (e.g., example shown in FIG. 7), defined based on regulatory requirements, automatically defined (e.g., randomly determined, be every combination or permutation of traits or trait parameter values, etc.), and/or otherwise determined. Checks can be related to: a device used by the user (e.g., during initial user registration, when inputting trait instances, etc.), personally identifiable information (PII), document capture, biometric information (e.g., a selfie), comparisons between different instances of the same trait, a combination thereof, and/or any other suitable information; example shown in FIG. 11. Examples of checks include: whether the device is an aggregator, whether the device is block listed, whether the device is jailbroken, whether the device is using an anonymous proxy type, whether the device has been seen at least a predetermined rate (e.g., the device has been seen at least 5 times a day), whether device is routed from Tor network, whether the device is a Tor exit node, whether device unusual activity has been detected, whether the device is using a VPN, whether the device is using an open proxy, whether the device has been previously trusted, whether browser anomaly has been detected, whether the IP address is from an OFAC block listed country, whether the IP address is from a block listed state, whether malware has been detected, whether the phone number matches the email address, whether the SSN is deceased, whether the full name is on OFAC sanctions list, whether the full name is on PEP list, whether the phone number matches the full name, whether the phone number matches the address, whether the phone number matches the email address, whether the birthdate matches the last name, whether the birthdate matches the SSN, whether the address matches the full name, whether the address matches the last name, whether the address matches the phone number, whether the last name matches the SSN, whether the full name matches the SSN, whether the birthdate matches the SSN, whether the address matches the SSN, whether the government ID has been recently re-used, whether the government ID is likely authentic, whether the government ID has expected number of portraits, whether the front and/or back of the government ID is suspicious, whether the government ID is a public sample, whether the government ID is expired, whether the selfie passes liveness, whether the selfie matches the portrait on the government ID, and/or any other suitable check; examples shown in FIG. 13, FIG. 14, FIG. 15, and FIG. 16.

A check preferably includes a set of check logic and a set of traits, and can optionally include values for one or more trait parameters of each trait (e.g., specify the source for the trait instance, specify the trait identifier, etc.). In operation, a user's trait instances (satisfying the trait parameter values) are evaluated using the check logic. However, the check can be otherwise defined.

Check logic functions to define the set of logical operators to execute on the trait instances and/or derivatives thereof. Examples of check logic that can be used include: comparison logic (e.g., operators that compare values and return true or false; operators that combine multiple Boolean expressions or values and provide a single Boolean output; etc.), conditional logic (e.g., if/else/then statements), decision trees, and/or any other suitable logic. In a first illustrative example, the check logic can determine whether the trait values from two trait instances are equal (e.g., trait instance 1 value=trait instance 2 value?). In a second illustrative example, the check logic can determine whether the trait value is greater than or lower than a predetermined value. In a third illustrative example, the check returns TRUE when a difference between trait instance values is less than a predetermined threshold (e.g., difference between trait instance values<predetermined threshold?).

A check can optionally include transformation steps (e.g., pre- or post-processing steps) to transform the trait instances into a trait instance derivative. Examples of transformations can include: differences, summations, products, mathematical derivatives, and/or any other transformation. For example, a check can sum the number of trait instances, determine the duration between different instances of a given trait, determine a spread or standard deviation between trait values for a given trait, and/or otherwise transform the trait instances.

A check can output one or more check values. Check values (e.g., internal-level check values, external-level check values, specification values) can be categorical (e.g., pass, fail, manual review, etc.), numerical (e.g., on a scale 1-10), Boolean and/or non-Boolean, and/or any other suitable data types. Check values can include metadata (e.g., time of when the check is performed, identifiers of the trait instances that were used to produce the internal-level check value, identifier for the check used to produce the check value, analysis explaining the check value, etc.) or not include metadata. For example, if a user on the OFAC sanctions list is TRUE within a check, metadata associated with the check value includes which countries' sanctions list the user is on. The metadata can be: determined when performing the check, extracted from trait instances, determined using a model, and/or otherwise determined. Check values can be invalidated (e.g., when a trait instance used to generate the check value is invalidated; etc.), validated, stored (e.g., in association with the trait instances used to generate the check value; in association with the user; etc.), removed, not stored, retrieved from a user database 140 (example shown in FIG. 22), reused for a different specification (e.g., reused to evaluate a different specification; example shown in FIG. 21), and/or otherwise managed.

Checks can be nested or unnested. In a first example where checks are nested, a check can be performed using the outcome of a prior check, which, in turn, can be performed using the outcome of a prior check. However, the checks can have any other suitable hierarchy.

In variants, the checks can include: internal-level checks, external-level checks, specifications, and/or any other suitable checks.

Internal-level checks are preferably atomic (e.g., uninterruptible, synchronous, cannot be subdivided into a smaller logical operation, etc.), but can alternatively not be atomic. In an illustrative example, an internal-level check for verifying a user's SSN can be defined as: trait 1=SSN from source X, trait 2=SSN from source Y, comparison=match? (e.g., SSN from source X=SSN from source Y?). Internal-level checks are preferably generic across specifications, but can alternatively be specific to a specification, and/or otherwise generic and/or specific. Internal-level checks and/or internal-level check values are preferably not exposed (e.g., hidden on the interface 130) to the user and the entity, but can additionally and/or alternatively be exposed to the user, exposed to the entity, and/or otherwise exposed.

External level checks can include one or more sub-checks and external-level check logic, or be otherwise defined. The sub-checks can be: internal-level checks, other external-level checks (e.g., that, in turn, include sub-checks), and/or any other check. Additionally or alternatively, external-level checks can be defined by only check logic, only one or more internal-level checks, and/or any other suitable check parameters. In an illustrative example, an external-level check for verifying a user's driver's license can include: at least a majority of the following internal-level checks returning TRUE: name and birthdate match birth records; address matches residency records; and driver's license photo matches user selfie.

External-level checks and/or external-level check values are preferably exposed to the entity, but can additionally and/or alternatively be exposed to the user, not exposed to the entity, not exposed to the user, and/or otherwise exposed. In an example, external-level checks and external-level check values are exposed to the entity. In another example, external-level checks are exposed to the entity, but external-level check values (e.g., SSN, driver's license) are not exposed to the entity (e.g., crypto institutions). External-level checks can be generic across specifications, specific to a specification, and/or otherwise generic and/or specific.

However, checks can be otherwise configured.

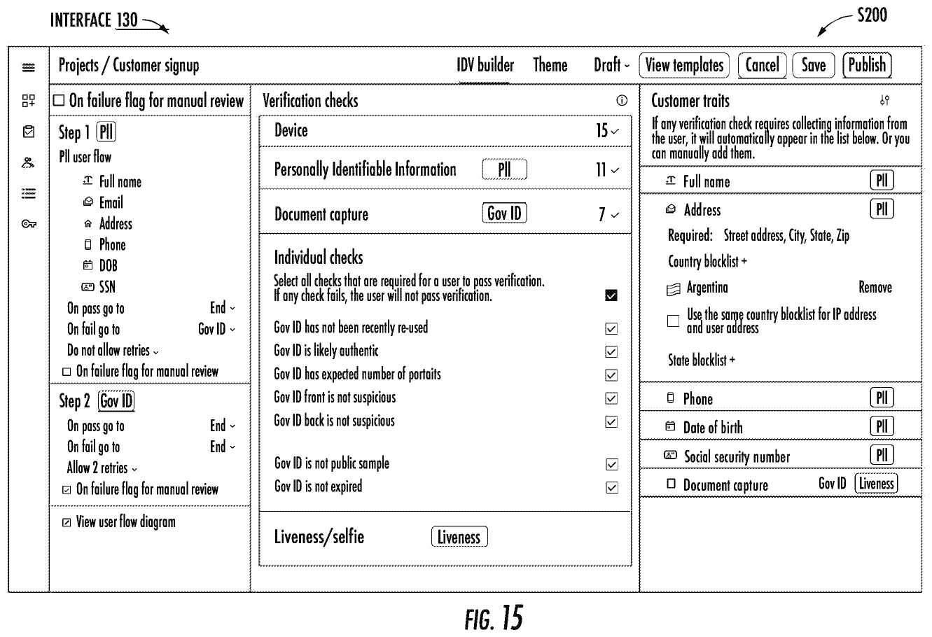

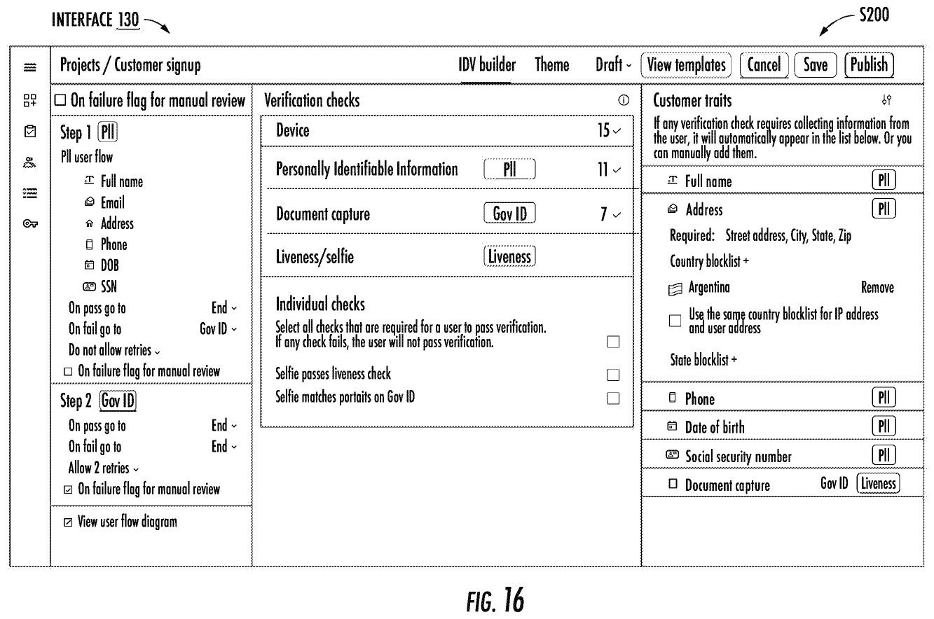

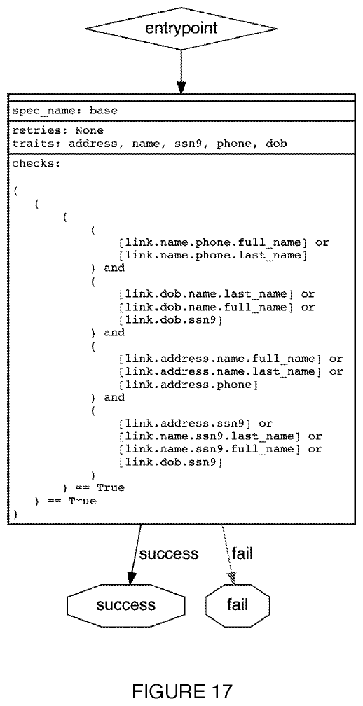

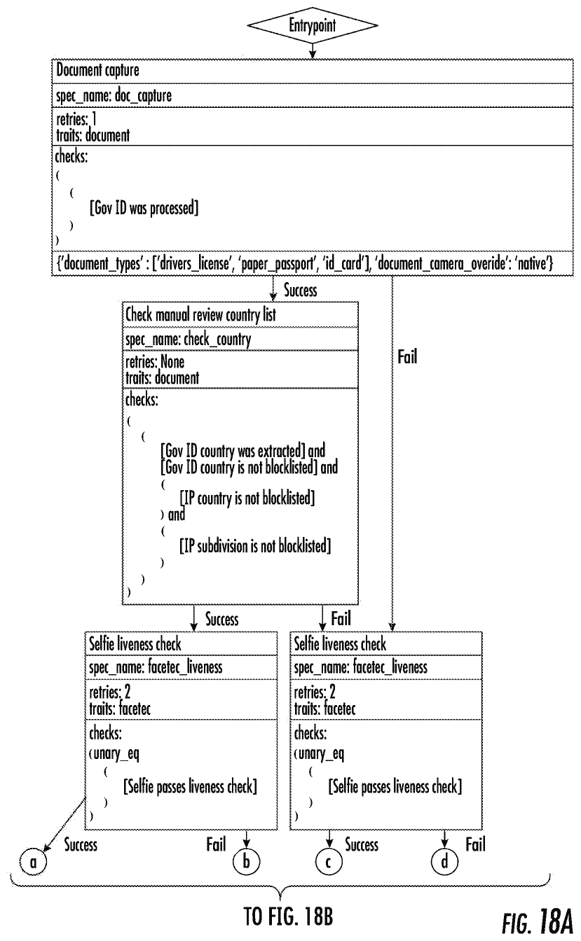

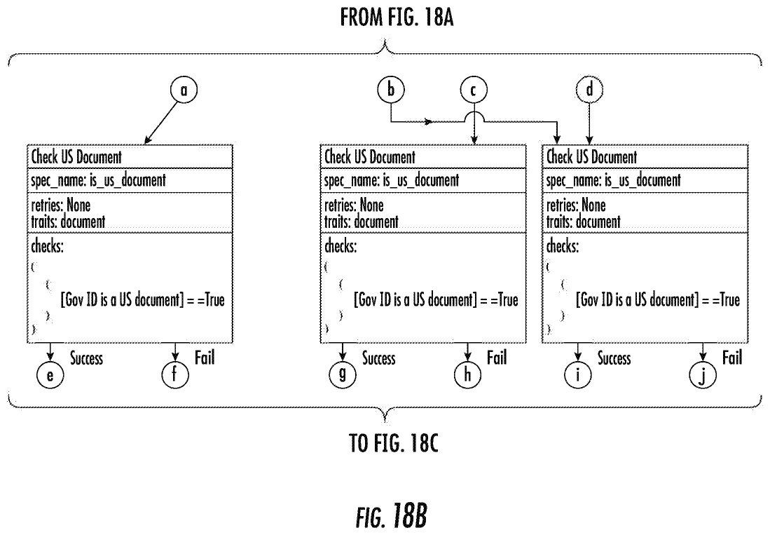

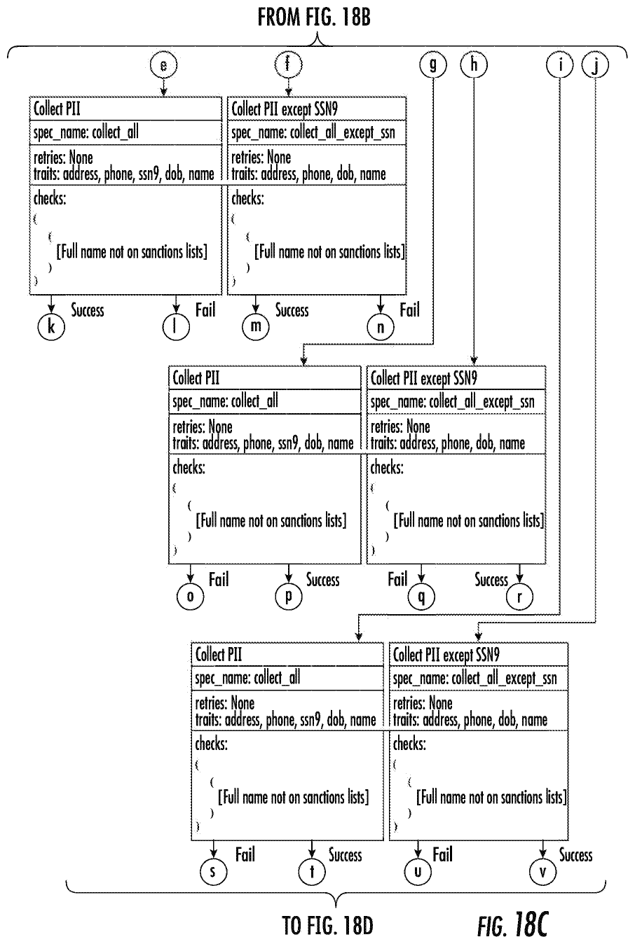

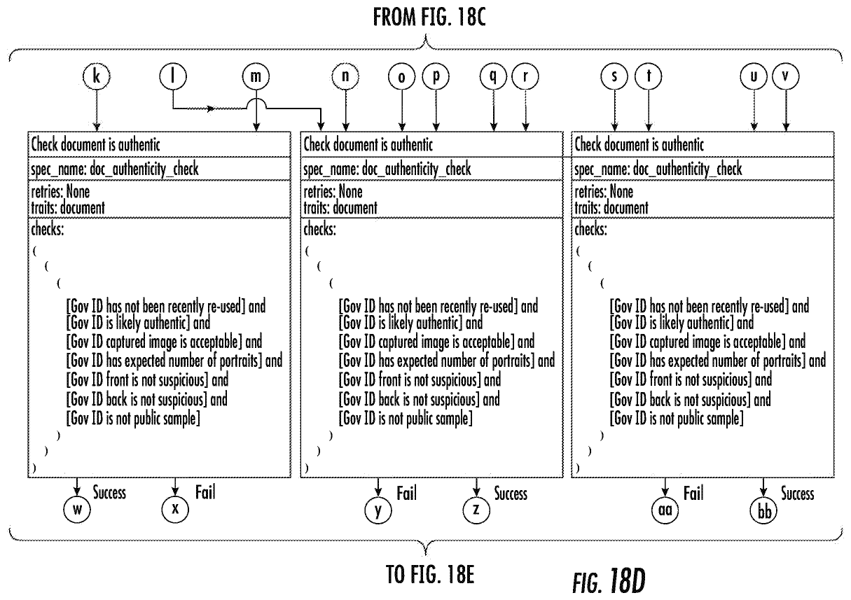

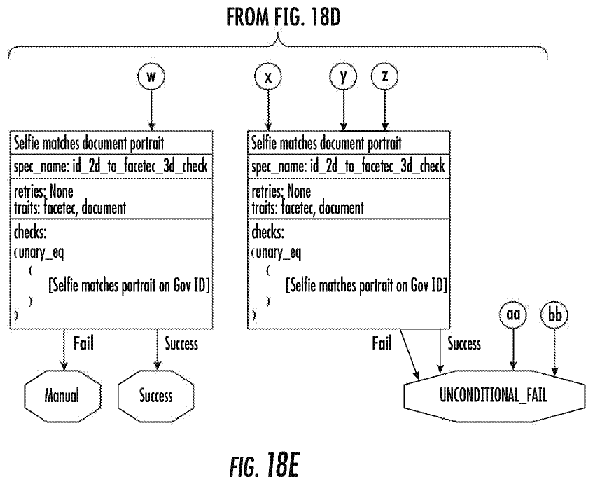

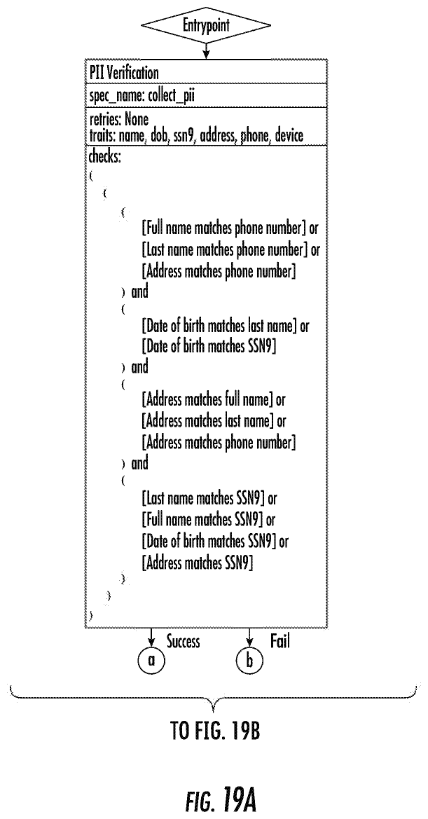

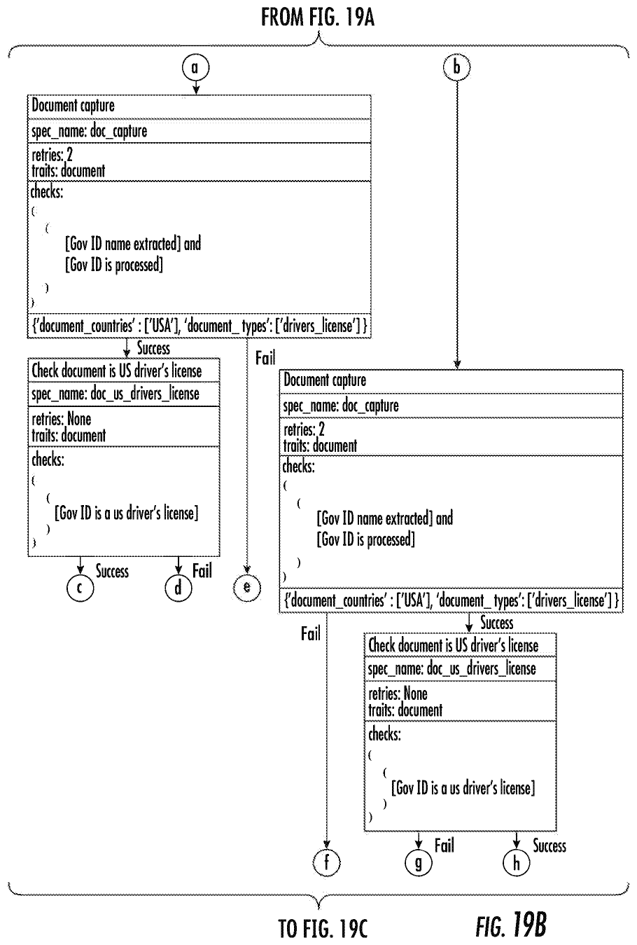

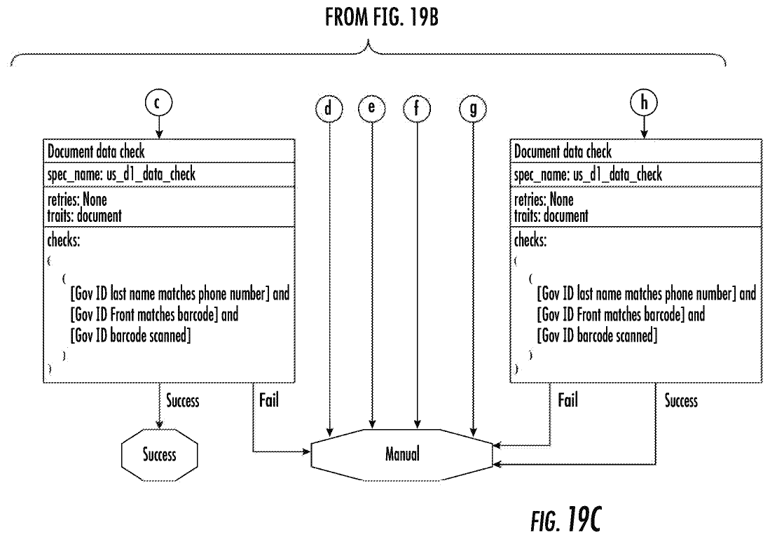

Specifications function to define the customer identification process for a given entity, and define which pieces of user information should be verified, and how they should be verified; examples shown in FIG. 17, FIG. 18, and FIG. 19. Each specification can be specific to an entity, specific to a user segment of an entity, and/or be otherwise specific or generic. Specifications can include a set of logical checks on the trait instances. The set of logical checks can be arranged in a series, a hierarchy (e.g., a nested hierarchy), and/or otherwise organized. Specifications are preferably defined by one or more external-level checks and check logic, but can additionally and/or alternatively be defined by only check logic, only one or more external-level checks, one or more internal-level checks (e.g., external-level checks are pre-defined and pre-associated with a pre-determined set of internal-level checks) and/or check logic, and/or any other suitable check parameters. In an illustrative example, a specification for verifying a user's identity can include a compilation of multiple external-level checks (e.g., verifying driver's license, verifying passport, and verifying birth certificate). Each specification can be in a form of a customer identification process (e.g., a customer identification program), a document, a decision tree, a graph, a program (e.g., written in computer programming language) and/or any other suitable structure. Each specification is preferably specific to an entity, but can additionally and/or alternatively be generic among entities, specific to a user segment, generic among user segments, and/or be otherwise specific and/or generic. Each specification can be globally unique or nonunique.

Each specification preferably includes one or more evaluation levels connected by progression logic (e.g., a decision tree), but can alternatively be otherwise structured. Each evaluation level preferably includes a set of checks and comparison logic (example shown in FIG. 7), but can alternatively include only comparison logic, only a set of checks, and/or any other suitable evaluation component. At each evaluation level, the specification can define: a trait, trait parameter values (e.g., source that the trait value must be obtained from), whether prior trait instances can be used for a given trait, and/or any other suitable trait parameter requirements; example shown in FIG. 7. Trait parameter requirements are preferably defined in the check definition, but can alternatively be a global definition (e.g., wherein the system automatically applies the trait requirement to all relevant trait instances when executing the specification), and/or otherwise defined. At each evaluation level, the set of checks can include one or more external-level checks, one or more internal-level checks, and/or any other suitable checks. The progression logic can include whether the output of an evaluation level can be treated as identity (e.g., validated such as pass, not validated such as fail, go to next evaluation level(s), and/or any other suitable logic. For example, a specification can include a decision tree, wherein each decision tree node (e.g., evaluation level) can include a set of sub-checks and comparison logic. The sub-checks can be external-level checks, internal-level checks, and/or any other check. The result values of each node (e.g., evaluation level) can be associated with: a child node (e.g., successive evaluation level), a specification value (e.g., “pass”, “fail”, “manual review”, etc.), and/or otherwise used.

In an example, a specification can include: a series of evaluation levels, wherein each evaluation level includes a set of external-level checks and/or internal-level checks. Each external-level check can itself include a set of internal-level checks, wherein the traits identified in the internal level checks can have defined or undefined trait parameter values. For example, the traits identified in the internal level checks can have specific sources that the trait must be obtained from (e.g., from the user, photo of a driver's license, from a specific third-party data provider, etc.), wherein only user trait instances obtained from those specific sources are used during specification evaluation.

Each specification is preferably defined by the entity, but can additionally and/or alternatively be defined by a user, by the platform, and/or otherwise defined. In a first example, a customer identification process can be received from an entity. In a second example, a customer identification process can be built by an entity on an interface 130 (e.g., by coding the set of logic, by dragging-and-dropping check icons in a GUI, by selecting and/or unselecting checks, etc.). However, the specification can be otherwise defined. Specifications and/or specification values can be exposed to the user, exposed to the entity, not exposed to the user, not exposed to the entity, and/or otherwise exposed.

However, specifications can be otherwise configured.

The system 10 can include one or more computing systems 110, which can function to execute one or more modules of the system 10. The computing system 110 is preferably a remote computing system such as a platform, but can additionally and/or alternatively be performed by: a distributed computing system, a local computing system, a centralized computing system, any/or be otherwise configured. The computing system 110 can execute the identity verification system 120, portions thereof, and/or any other suitable component. The remote computing system 110 (e.g., platform) preferably interfaces with users directly (e.g., using an interface 130, but can alternatively interface with users indirectly, not interface with users, and/or otherwise interface with users. The remote computing system 110 preferably interfaces with entities directly (e.g., using an interface 130, but can alternatively interface with entities indirectly, not interface with entities, and/or otherwise interface with entities.

However, the one or more computing systems 110 can be otherwise configured.

The system 10 can include one or more identity verification systems 120, which can function to perform one or more elements of the method.

The identity verification system 120 can include one or more modules. The modules can include any number of the following modules, arranged in any suitable order. The modules can include: a specification determination module, a user data determination module, a verification module, and/or any other suitable module.

The modules can include a specification determination module, which can function to determine an entity-specific specification for identity verification. The specification determination module can include: an interface 130 (e.g., GUI and/or coding interface; wherein an entity selects and/or unselects which checks to be performed for users; wherein an entity uploads a specification; wherein an entity selects an existing specification from a database 140; etc.), a specification conversion model (e.g., converts a customer identification process into a specification), and/or any other suitable component for determining the specification. The specification conversion model can be and/or leverage: regression, classification, neural networks (e.g., CNNs, DNNs, etc.), rules, heuristics, equations (e.g., weighted equations, etc.), selection (e.g., from a library), instance-based methods (e.g., nearest neighbor), regularization methods (e.g., ridge regression), decision trees, Bayesian methods (e.g., Naïve Bayes, Markov), kernel methods, probability, deterministics, support vectors, statistics, and/or any other suitable method. For example, the specification conversion model is a natural language model that extracts traits and evaluation logic (e.g., for how to evaluate the traits) from a legal document. However, the specification determination module can be otherwise configured.

The modules can include a user data determination module, which can function to determine a set of user data (e.g., trait instances) to be checked for a user. The user data determination module can include: receiving user data (e.g., from users); retrieving user data (e.g., from third-parties); pre-processing user data (e.g., data cleaning, data reduction, data transformation, etc.); and/or otherwise determine the data. The user data determination module can be used by: a user, an entity, a third-party, and/or any other suitable individual, organization, and/or entity. The user data determination module can include: an interface 130 (e.g., GUI, coding interface, etc.) for entities (e.g., wherein an entity retrieves user data from a third-party); an interface 130 (e.g., GUI) for users (e.g., wherein users input data on the interface); and/or any other suitable component for determining user data. However, the user data determination module can be otherwise configured.

The modules can include a verification module, which can function to verify a user's identity based on the user data and checks defined in the entity-specific specification. The verification module can include: determining internal-level check values, external-level check values, evaluation level results, specification values, manual specification values, and/or metadata; returning (e.g., to an endpoint) internal-level check values, external-level check values, evaluation level results, specification values, manual specification values, and/or metadata; storing (e.g., for reuse) internal-level check values, external-level check values, evaluation level results, specification values, manual specification values, and/or metadata; and/or any other suitable component for verification. However, the verification module can be otherwise configured.

However, the one or more identity verification systems 120 can be otherwise configured.

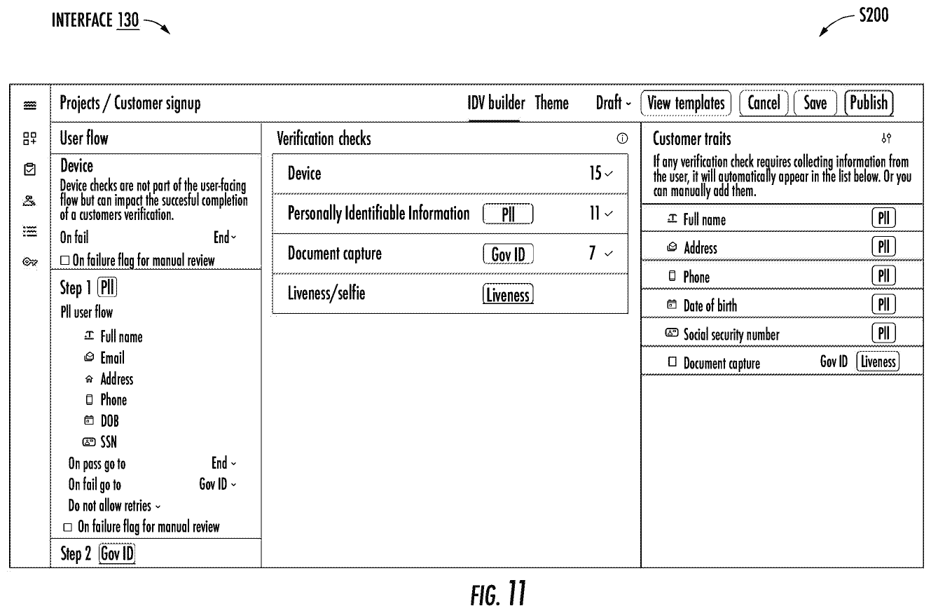

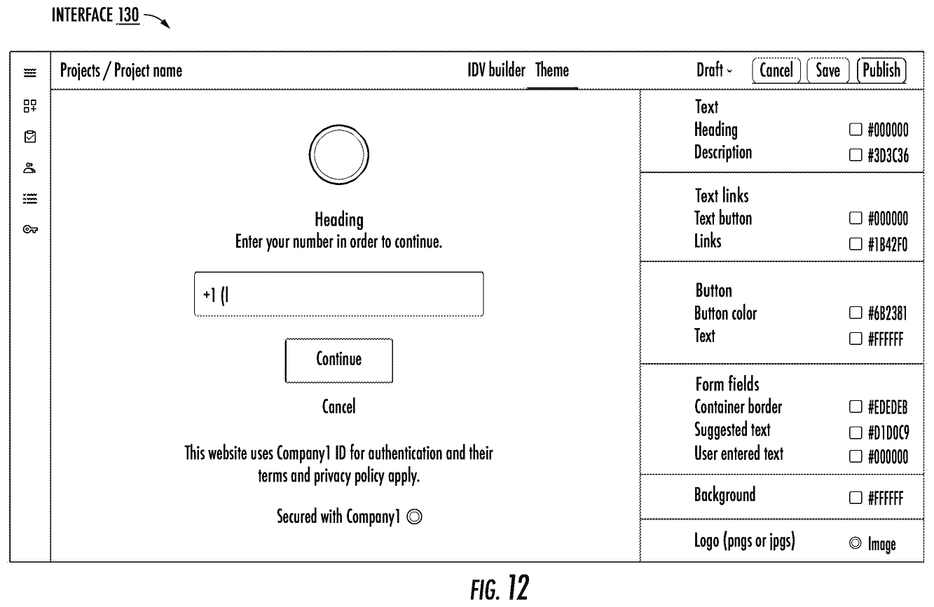

The system 10 can optionally include one or more interfaces 130, which can function to receive data from and/or present information to an entity and/or user. An entity and a user preferably have different interfaces 130, but can additionally and/or alternatively have the same interface 130. In an example, the interface 130 for users can: receive trait instances, present trait instances, present a summary of all entities for which the user is validated, and/or receive or present any other suitable information. In another example, the interface 130 for entities (e.g., separate from the interface 130 for users) can: receive a specification (e.g., external-level checks, internal-level checks, traits, evaluation logic, etc.), receive trait parameter values (e.g., for trait instance selection and/or retrieval), receive a graphical theme for the interface 130 used by users (example shown in FIG. 12), present checks (e.g., external-level checks, internal-level checks) to select and/or unselect (e.g., by the entity) when building a specification, present check values (e.g., external-level check values, internal-level check values) for a user, present a specification value for a user, present summary data for all users validated using the entity's specification, present metadata (e.g., analysis explaining the specification value), and/or receive or present any other suitable information.

The interface 130 is preferably a graphical user interface (GUI), but can additionally and/or alternatively be an application programming interface (API), a coding interface, a command line interface, a touch interface, a voice interface, an eye tracking interface, a facial motion interface, an email interface, and/or any other suitable type of interface. The interface 130 is preferably an application (e.g., browser application, native application, etc.) on a device (e.g., laptop, desktop, mobile phone, tablet, etc.), but can additionally and/or alternatively be an API, and/or any other suitable interface. The input and/or selection (e.g., by the user, by the entity, etc.) is preferably tactile based (e.g., pressing a digital button, dragging and dropping, checking boxes, etc.), but can additionally and/or alternatively be voice-based, motion-based, and/or any other suitable input and/or selection.

However, the one or more interfaces 130 can be otherwise configured.

The system 10 can optionally include one or more databases 140, which can function to store data (e.g., for one or more users) such as: information received from a user (e.g., trait instances), information received from an entity (e.g., specification, trait parameter values, etc.), information retrieved from a third-party (e.g., using an API call, downloaded, etc.), information determined by the method (e.g., specification values, evaluation level results, external-level check values, internal-level check values, entities one or more users have been verified for, etc.), and/or any other suitable information. Examples of databases can include: user databases, specification databases, traits databases, logic databases, third-party databases, databases of external-level check groupings, databases of internal-level check groupings, and/or any other suitable database. The database 140 can be a NoSQL database, a relational database (RDS), a hierarchical database, a distributed database, a centralized database, a cloud database, and/or any other suitable database. The data stored in the databases 140 can be determined automatically (e.g., via APIs, through an interface 130 such as a graphical user interface, etc.), manually (e.g., by an entity, by a manual reviewer, etc.), and/or otherwise determined.

However, the one or more databases 140 can be otherwise configured.

However, the system 10 can be otherwise configured.

### 5. Method

The method can include: receiving a request S100, determining a specification S200, determining a set of trait instances for a user S300, and verifying the user according to the specification S400. However, the method can be otherwise performed. One or more instances of the method can be repeated for different requests, specifications, traits, trait instances, users, entities, sources, creation times, time intervals, and/or otherwise repeated. All or portions of the method can be performed continuously, recurrently (e.g., annually, monthly, weekly, daily, hourly, etc.), upon receipt of a request (e.g., a verification request), and/or at any other suitable time and/or frequency.

The method is preferably performed by the system 10 disclosed above, but can additionally and/or alternatively be performed by any other suitable system.

### 5.1. Receiving a Request S100

Receiving a request S100 functions to determine that a verification of a user's identity is needed. However, S100 can have any other suitable functionality. S100 can be performed before S200, concurrently with S200, after S200, and/or any other suitable time. The request (e.g., verification request) can include one request, multiple requests, and/or any other suitable number of requests. The request is preferably received from an entity, but can additionally and/or alternatively be received from a third-party data provider, received from a user, and/or otherwise received. S100 can be performed when: a user logs into the platform through the entity (e.g., selects a “verify with Sora ID” option); when an entity requests verification; and/or performed at any other suitable time. The request preferably includes one or more user identifiers (e.g., phone number, email address, other immediately-verified credentials, etc.) for a user, but can additionally and/or alternatively include one or more entity identifiers (e.g., access token, entity name, etc.), one or more specification identifiers (e.g., useful when an entity is associated with multiple specifications for different verification levels and/or geographic regions), one or more internal-level check identifiers (e.g., to retrieve the user's pre-determined internal-level check values), and/or any other suitable information. The user identifier is preferably an immediately-verifiable credential, such as a phone number, email, biometric, authenticator application, or other credentials, but can additionally and/or alternatively be or include a credential that is not immediately verifiable (e.g., social security number, historic information, etc.). The user identifier is preferably a phone number or email address, but can additionally and/or alternatively be platform login credentials (e.g., username, password, etc.), biometrics, a user access token, one-time passwords (OTPs), HMAC-based one-time passwords (HOTPs), time-based one-time passwords (TOTPs), and/or any other suitable information. In variants, the user identifier can be used to retrieve the user's pre-determined internal-level check values from a database 140, wherein the internal-level check values are used to verify the user's identity in a future request received from a different entity.

However, the request can be otherwise received.

### 5.2. Determining a Specification S200

Determining a specification S200 functions to determine a set of user data (e.g., trait instances) and a set of entity-specific checks (e.g., external-level checks, internal-level checks, etc.) to perform on the user data. S200 can be performed after S100, concurrently with S100, concurrently with S300, before S300, when a specification is modified, and/or any other suitable time. The specification can include one specification, multiple specifications, and/or any other suitable number of specifications. S200 can be performed: in response to S100; when an entity initially sets up a platform account; and/or at any other time. The specification is preferably for the entity requesting user verification, but can additionally and/or alternatively be a generic specification, and/or any other suitable specification. The specification is preferably defined by one or more external-level checks and check logic, but can additionally and/or alternatively be defined by one or more internal-level checks (e.g., external-level checks are pre-defined and pre-associated with a pre-determined set of internal-level checks) and/or check logic, and/or any other suitable check parameters. The specification can be determined by the specification determination module in the identity verification system 120, received from an entity (e.g., verifying entity), automatically generated, and/or be otherwise determined.

In a first variant, S200 can include receiving the specification from an entity.

In a first embodiment, the entity builds a new specification using an interface 130 (example shown in FIG. 9). The interface 130 is preferably a GUI, but can additionally and/or alternatively be a coding interface, and/or any other suitable interface. The specification can be built using a template (example shown in FIG. lo) or not be built using a template. The template preferably includes a specific set of external-level checks (e.g., for the entity to select from on the interface 130), but can additionally and/or alternatively not be associated with a set of external-level checks. Examples of a template include: a basic verification template (e.g., only name, address, phone, and email), a PII template (e.g., basic verification template with addition of SSN/ITIN and birthdate), a government ID template (e.g., government ID image capture and/or upload), a liveness template (e.g., a selfie scan), a combination thereof (e.g., a PII and government ID template; a liveness and government ID template; a PII, government ID, and liveness template; etc.), and/or any other suitable template. The interface 130 preferably presents external-level checks to the entity and receives the selected external-level checks from the entity (examples shown in FIG. 13, FIG. 14, FIG. 15, and FIG. 16), but can additionally and/or alternatively receive a set of successive internal-level checks, one or more evaluation levels (e.g., a series of evaluation levels wherein each evaluation level includes a set of external-level checks and/or internal-level checks), and/or receive any other suitable information. The specification can be modified, saved, published, cancelled, deleted, copied, duplicated, and/or be otherwise used (e.g., by the entity). The specification can be associated with a mode (e.g., draft mode, sandbox mode, production mode, etc.) or not be associated with a mode.

In a second embodiment, the entity modifies an existing specification using an interface 130. For example, the entity modifies the specification by selecting and/or unselecting specific external-level checks presented to the entity on a GUI.

In a third embodiment, the entity provides their customer identification process (e.g., their customer identification program), and the customer identification process is converted into a specification (e.g., automatically, using a specification conversion model and/or ML; manually; etc.).

However, the specification can be otherwise received from the entity.

In a second variant, S200 can include retrieving the specification from a specification database 140 based on a specification identifier given by the entity (example shown in FIG. 22), wherein the specification was previously defined.

However, the specification can be otherwise determined.

### 5.3. Determining a Set of Trait Instances for a User S300

Determining a set of trait instances for a user S300 functions to obtain the set of user data (e.g., trait instances) to be checked. S300 can be performed after S100, concurrently with S100, before S100, after S200, upon initial user signup, when a trait instance is invalidated (e.g., validity time expires, automatic expiration time has passed, etc.), periodically, and/or any other suitable time. The set of trait instances can be determined by the user data determination module in the identity verification system 120 and/or be otherwise determined.

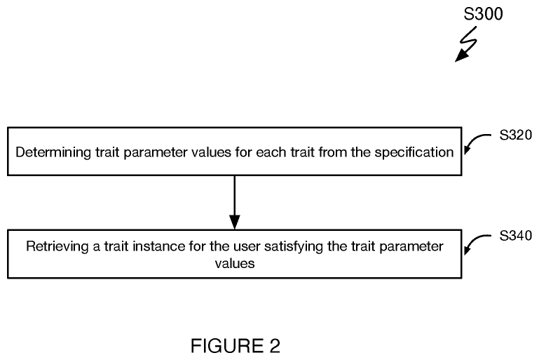

As shown in FIG. 2, S300 can include: determining trait parameter values for each trait from the specification S320, and determining a set of trait instances for the user satisfying the trait parameter values S340. However, the set of trait instances to evaluate can be otherwise determined.

Determining trait parameter values for each trait from the specification S320 functions to determine the conditions that the retrieved trait instances must satisfy. The trait parameter values are preferably specified in the specification, more preferably specified by the internal-level checks of the specification, but can additionally and/or alternatively be defined by the entity, and/or otherwise defined.

Determining a set of trait instances for the user satisfying the trait parameter values S340 functions to obtain user data for subsequent analysis. Trait instance sets for all evaluation levels are preferably retrieved before check execution, but can additionally and/or alternatively be serially retrieved on an evaluation level-by-evaluation level basis, retrieved on-the-fly, and/or retrieved at any other suitable time.

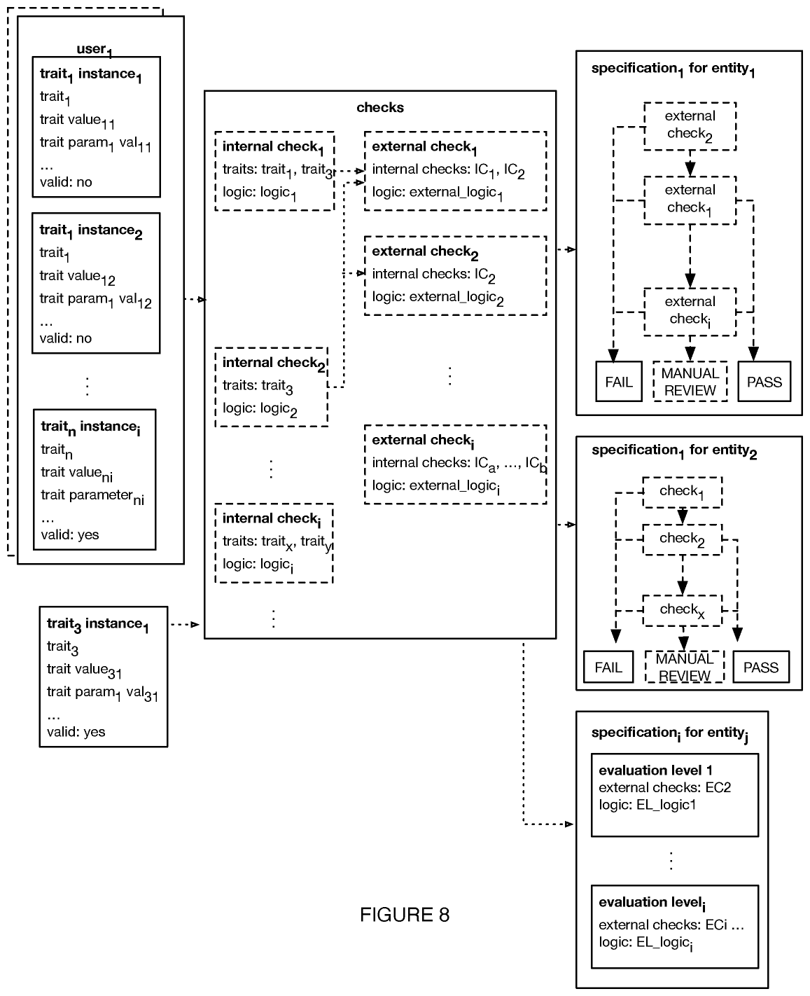

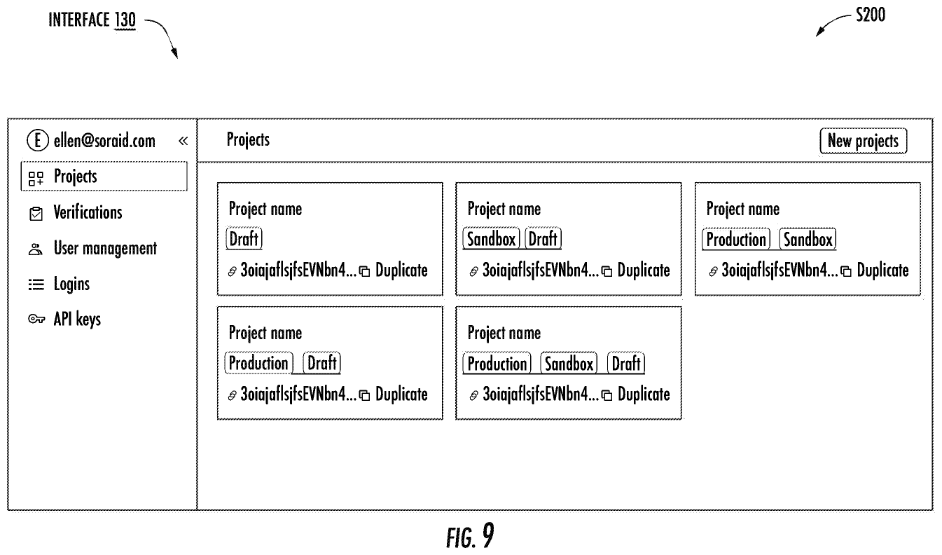

In a first variant, S340 includes retrieving trait instances for the user satisfying the respective trait parameter values from storage (e.g., a user database 140); example shown in FIG. 8.

In a second variant, S340 can include receiving one or more trait instances for the user from an external source (and/or generating a trait instance upon trait value receipt from the external source). In this variant, the resultant trait instances can be immediately used and/or stored in association with the user. In embodiments, a trait instance is retrieved and/or received from the same source as a previous trait instance (e.g., for the same trait), the previous trait instance can be invalidated (e.g., the previous trait instance is still stored in the database 140 but can be retraced).

In a first embodiment, one or more trait instances for the user are retrieved from one or more third-parties (e.g., data provider such as Experian™, Equifax™, TransUnion™, etc.). Multiple third-parties can provide a trait instance for the same trait, or a single third-party can provide a trait instance for a trait. In a first example, when multiple third-parties can provide a trait instance for the same trait, the system 10 selects a third-party (e.g., based on the entity's preferences) to send an API call for trait instance retrieval. In a second example, when multiple third-parties can provide a trait instance for the same trait, the system 10 sends API calls in series or in parallel to the third-parties for trait instances retrieval. The third-parties are preferably not exposed (e.g., hidden on the interface 130) to the entity, but can additionally and/or alternatively be exposed to the entity, be specified by the entity (e.g., in the specification), and/or otherwise exposed.

In a second embodiment, one or more trait instances for the user are received from the user (e.g., directly, indirectly via the entity, etc.) using an interface 130. In a first example, a user inputs a trait instance for a trait after being instructed to do so (e.g., takes a photo of the user's face). In a second example, a user proactively inputs a trait instance for a trait on an interface 130. The interface for user trait instance entry can be provided through the validating entity (e.g., through the validating entity's interface) or through a separate interface (e.g., the platform's interface).

In a third variant, S340 can include a combination of the above variants (e.g., same or different trait instances for the same trait can be obtained in different ways). In a first embodiment, a trait value is received from a user, a trait instance is generated based on the trait value, and the trait value is transmitted to a third-party. The trait value is processed by the third-party and trait values one or more different traits are sent by the third-party to the platform based on the trait values. In a second embodiment, a first trait instance is retrieved from a database 140 and a second trait instance is retrieved from a third-party (e.g., for the same or different traits). In a third embodiment, trait instances are preferentially pulled from storage, and retrieved when no valid trait instances satisfying the trait parameter values exist (example shown in FIG. 8).

When multiple trait instances for the specification-specified set of trait parameter values exist (e.g., the trait instances or trait values conflict or do not match), more recent trait instances can be prioritized for use. For example, for a trait of interest, the most recent trait instance is selected based on creation time regardless of differences in source. Additionally and/or alternatively trait instances can be otherwise prioritized.

However, the set of trait instances for a user can be otherwise determined.

S300 can optionally include determining auxiliary trait instances for the user for future evaluation. The auxiliary trait instances for the user are preferably not determined based on the specification determined in S200, but additionally and/or alternatively be determined based on the specification determined in S200. The auxiliary trait instances for the user are preferably used to verify the user using a different specification (e.g., with different checks) than the specification determined in S200, but can additionally and/or alternatively be used to verify the user using the specification determined in S200, and/or otherwise used. The auxiliary trait instances can be determined for: a particular set of users only, a specific user only, randomly selected users, and/or otherwise determined. The auxiliary trait instances are preferably received from an external source (e.g., from the user, from a third-party, etc.), but can additionally and/or alternatively be retrieved from a database 140, and/or otherwise determined. However, the auxiliary trait instances can be otherwise determined.

The method can optionally include retrieving check values (e.g., internal-level check values, external-level check values, etc.) for a user. The check values are preferably retrieved from a database 140 (e.g., user database), but can additionally and/or alternatively be retrieved from a third-party, retrieved from an entity, and/or be otherwise retrieved. The check values are for checks performed using the retrieved trait instances, but can additionally and/or alternatively be for checks not performed using the retrieved trait instances. However, the check values for a user can be otherwise retrieved.

### 5.4. Verifying the User According to the Specification S400

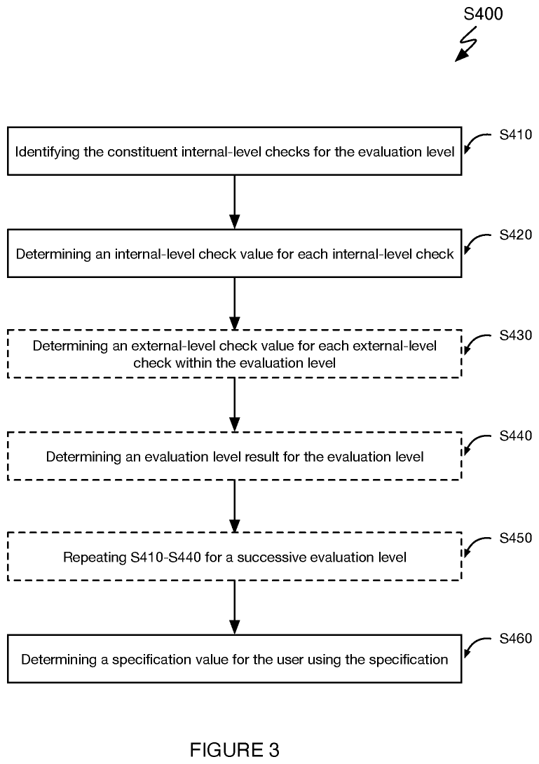

Verifying the user according to the specification S400 functions to verify a user's identity based on checks defined in the specification. As shown in FIG. 3, for each successive evaluation level in the specification, S400 can include: identifying the constituent internal-level checks for the evaluation level S410; determining an internal-level check value for each internal-level check S420; optionally determining an external-level check value for each external-level check within the evaluation level S430; optionally determining an evaluation level result for the evaluation level S440; when the evaluation result is associated with a successive evaluation level, optionally repeating S410-S440 for the successive evaluation level S450; and determining a specification value of the user for the specification S460. However, S400 can be otherwise performed. S400 can be performed after S300, concurrently with S300, when a trait instance is invalidated, when a specification is modified, and/or any other suitable time. The user can be verified by the verification module in the identity verification system 120 and/or be otherwise determined.

Identifying the constituent internal-level checks for the evaluation level S410 can include identifying each internal-level checks within an evaluation level and/or specification (e.g., by introspecting any higher-level checks). The specification can include: one or more evaluation levels, one or more external-level checks (e.g., within an evaluation level, separate from an evaluation level, etc.), one or more internal-level checks (e.g., within an evaluation level, within an external-level check, separate from an evaluation level, separate from an external-level check, etc.), and/or any other suitable component. For example, the specification can include: a series of evaluation levels, wherein each evaluation level includes a set of external-level checks and/or a set of internal-level checks, wherein each external-level check itself can include a set of internal-level checks.

In a first variant, S410 can include identifying all external-level checks within the evaluation level, and for each external-level check, identifying all the internal-level checks within each external-level check.

In a second variant, S410 can include identifying all internal-level checks within the evaluation level.

However, the internal-level checks can be otherwise identified.

Determining an internal-level check value for each internal-level check S420 functions to determine a value for each internal-level check, which can be subsequently used to determine external-level check values. Examples of internal-level check values can be: pass, fail, maybe, a numerical “score”, recheck, null, unknown, perform a different check, and/or any other suitable values.

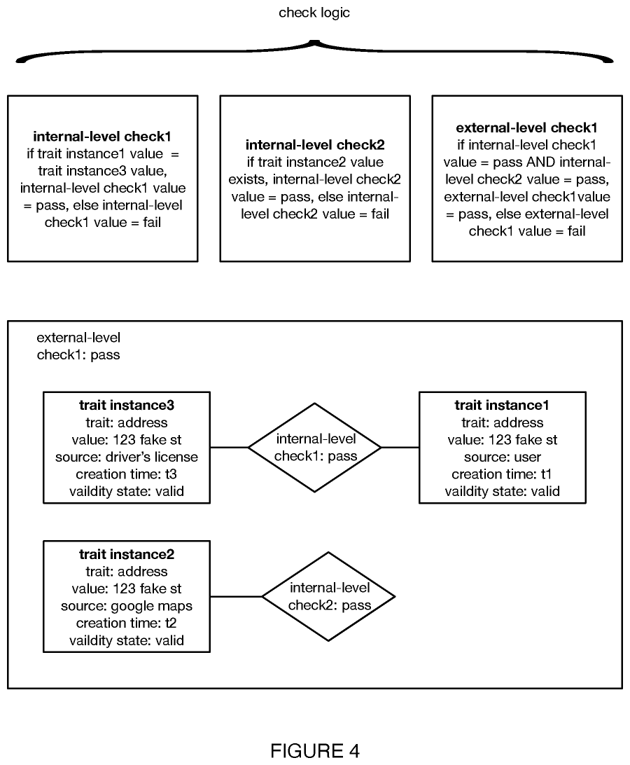

In a first variant, S420 can include comparing trait instances (e.g., satisfying the internal check's trait parameter value requirements) according to the check logic and determining an internal-level check value based on the comparison; example shown in FIG. 4. The resultant internal-level check value can be stored (e.g., in association with the underlying trait instances) for future reuse and/or otherwise used.

In a second variant, S420 can include retrieving a previously-determined internal-level check value (e.g., from a prior execution instance of the same or different specification) from a user database 140 (example shown in FIG. 22). In this variant, the previously-determined internal-level check value can be retrieved based on: an identifier for the trait instance, an identifier for the internal-level check, an identifier for the user, and/or any other information.

In a third variant, S420 can include retrieving an internal-level check value from a third-party (e.g., using a request to the third party). However, the internal-level check value can be otherwise determined.

S420 can optionally include returning the internal-level check value through an interface 130 (e.g., mobile application, web application, an API, etc.). The internal-level check value is preferably returned to the entity (e.g., in association with the user identifier), but can additionally and/or alternatively be returned to the user (e.g., associated with the internal-level check value), returned to a third-party (e.g., data provider), and/or be otherwise returned. However, the internal-level check value can be otherwise returned.

S420 can optionally include storing the internal-level check value in a database 140. The internal-level check value is preferably stored in association with the user and/or user identifier, but can additionally and/or alternatively be stored in association with an entity identifier, a specification identifier, metadata (e.g., for the trait value, the check, etc.; check evaluation time, data source, etc.) and/or any other identifier. The internal-level check value can be stored for: lookup in the database 140, determination of a different internal-level check value, determination of an external-level check value, determination of an evaluation result, determination of a specification value, determination of metadata, and/or be otherwise reused. However, the internal-level check value can be otherwise stored.

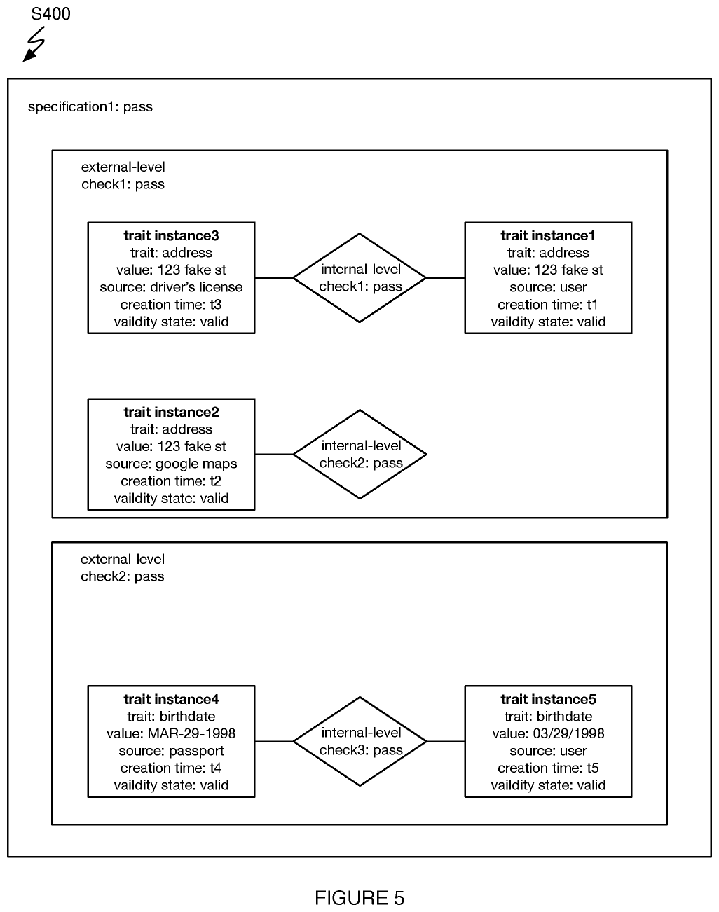

Determining an external-level check value for each external-level check within the evaluation level S430 functions to determine intermediary check values that summarize or interpret the results of one or more underlying internal-level checks. Examples of external-level check values can be: pass, fail, maybe, a numerical “score”, recheck, null, unknown, perform a different check, and/or any other suitable values. In a first variant, S430 can include determining an external-level check value based on the internal-level check values for the internal-level checks collectively forming the external-level check, wherein the external-level check logic is defined by the external-level check; example shown in FIG. 5. For example, if the external-level check requires all internal-level checks to pass, then if all of the internal-level check values are “pass,” the external-level check value is “pass.” Otherwise, the external-level check value is “fail.” In a second variant, S430 can include retrieving a previously-determined external-level check value (e.g., from a prior execution instance of the same or different specification). In this variant, the previously-determined external-level check value can be retrieved based on: the identifiers for the underlying trait instances, the identifiers for the underlying internal-level checks, the identifier for the external-level check, an identifier for the user, and/or any other information. In a third variant, S430 can include retrieving an external-level check value from a third-party. However, the external-level check value can be otherwise determined.

S430 can optionally include determining an auxiliary external-level check value for an auxiliary external-level check. The auxiliary external-level check is preferably not defined in the specification determined in S200, but can additionally and/or alternatively be defined with the specification in S200, and/or otherwise associated with the specification in S200. The auxiliary external-level check is preferably defined by an entity, but can additionally and/or alternatively be defined by a third-party, and/or by any other suitable party. The auxiliary external-level check value is preferably used to verify the user using a different specification (e.g., with different checks) than the specification determined in S200, but can additionally and/or alternatively be used to verify the user using the specification determined in S200, and/or be otherwise used. The auxiliary external-level check value is preferably determined based on auxiliary trait instances, but can additionally and/or alternatively be determined based on internal-level check values, and/or be otherwise determined. However, the auxiliary external-level check value can be otherwise determined.

S430 can optionally include returning the external-level check value and/or auxiliary external-level check value through an interface 130 (e.g., mobile application, web application, an API, etc.). The external-level check value is preferably returned to the entity (e.g., in association with the user identifier), but can additionally and/or alternatively be returned to the user (e.g., associated with the external-level check value), returned to a third-party (e.g., data provider), and/or be otherwise returned. However, the external-level check value and/or auxiliary external-level check value can be otherwise returned.

S430 can optionally include storing the external-level check value in a database 140. The external-level check value is preferably stored in association with the user and/or user identifier, but can additionally and/or alternatively be stored in association with an entity identifier, a specification identifier, and/or any other identifier. The external-level check value can be stored for: lookup in the database 140, determination of a different external-level check value, and/or be otherwise reused. However, the external-level check value and/or auxiliary external-level check value can be otherwise stored.

Determining an evaluation level result for the evaluation level S440 functions to determine a value for an evaluation level using check values and logic. The evaluation level result can be categorical and/or numerical, Boolean and/or non-Boolean, and/or any other suitable data attributes. Examples of evaluation level results can be: pass, fail, maybe, a numerical “score”, recheck, null, unknown, perform a different check, and/or any other suitable values. The evaluation level result can be associated with one or more successive evaluation levels in the specification, or not be associated with successive evaluation levels in the specification. In a first example, if external-level check 1's value is greater than external-level check 2's value, the next evaluation level is proceeded. If external-level check 1's value is equal to external-level check 2's value, the evaluation level result is “pass.” If the external-level check 1's value is less than external-level check 2's value, the evaluation level result is “fail.” However, the evaluation level result can be otherwise determined.

S440 can optionally include returning the evaluation result through an interface 130 (e.g., mobile application, web application, an API, etc.). The evaluation result is preferably returned to the entity (e.g., in association with the user identifier), but can additionally and/or alternatively be returned to the user (e.g., associated with the evaluation result), returned to a third-party (e.g., data provider), and/or be otherwise returned. However, the evaluation result can be otherwise returned.

S440 can optionally include storing the evaluation result in a database 140. The evaluation result is preferably stored in association with the user and/or user identifier, but can additionally and/or alternatively be stored in association with an entity identifier, a specification identifier, and/or any other identifier. The evaluation result can be stored for: lookup in the database 140, determination of a different evaluation result, and/or be otherwise reused. However, the evaluation result can be otherwise stored.

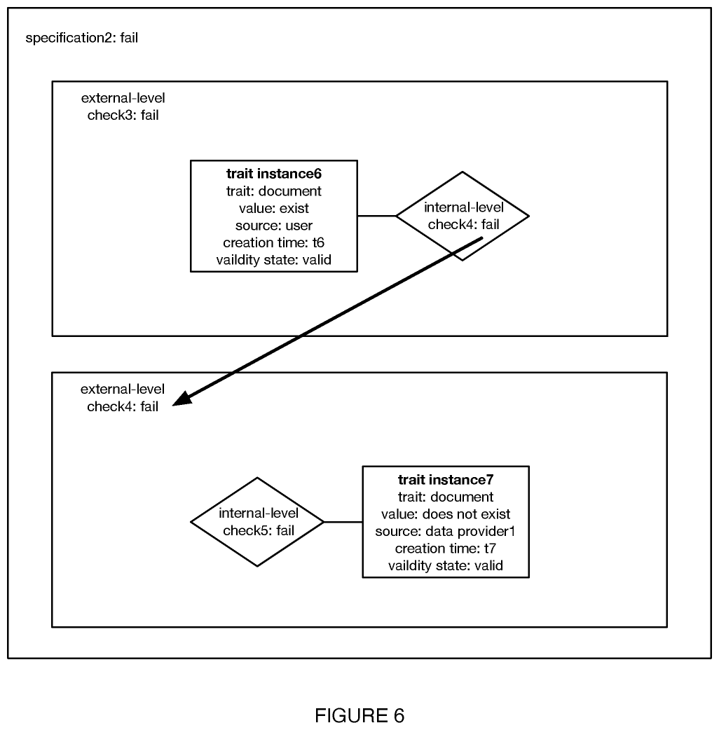

When the evaluation result is associated with a successive evaluation level, all or a portion of S410-S440 can be repeated for the successive evaluation level S450; example shown in FIG. 6. This can enable complex decision logic to be automatically executed by the specification. However, S410-S440 for the successive evaluation level can be otherwise repeated.

Determining a specification value of the user for the specification S460 functions to determine a final value representing whether a user's identity is verified based on the specification. The specification value of the user for the specification can be determined based on internal-level check values, external-level check values, evaluation level results, a specification, a request, traits, trait instances, trait parameter values, third-party data, user input data, and/or any other suitable information. Examples of specification values can include: pass, fail, invalidated, validated, manual review, null, unknown, and/or any other suitable value. The specification value is preferably determined automatically, but can additionally and/or alternatively be determined manually (e.g., by a reviewer on an interface 130), and/or otherwise determined.

In a first variant, S460 can include determining a specification value based on the determined internal-level check values and the specification. For example, each permutation of internal-level check values can be associated with “pass,” “fail,” or “manual review.” If the specific permutation of internal-level check values is associated with “pass,” the specification value is “pass.” If the specific permutation of internal-level check values is associated with “fail,” the specification value is “fail.” If the specific permutation of internal-level check values is associated with “manual review,” the specification value is “manual review.”

In a second variant, S460 can include determining a specification value based on the determined external-level check values (e.g., determined based on internal-level check values) and the specification. In an example, if all of the external-level check values are “pass,” the specification value is “pass.” Otherwise, the specification value is “fail.” In another example, if all of the external-level check values are “pass,” the specification value is “pass.” Else if all of the external-level check values are “pass” except a specific set of external-level check values are “fail,” the specification value is “manual review.” Otherwise, the specification value is “fail.”

In a third variant, S460 can include determining a specification value based on the evaluation level result. For example, if the evaluation level result is “pass,” the specification value is “pass;” example shown in FIG. 8.

However, the specification value can be otherwise determined.

S460 can optionally include determining a manual check or specification value. The manual check or specification value is preferably determined by a reviewer (e.g., from a third-party, from an entity, example shown in FIG. 20, etc.) on an interface 130, but can additionally and/or alternatively be determined by any other suitable individual, determined automatically, and/or otherwise determined. The manual check or specification value is preferably determined when the check or specification value is “manual review,” but can additionally and/or alternatively be determined when the check or specification value is “fail,” when the request specifies a manual review requirement, when the check values satisfy a particular check permutation and/or condition, and/or any other suitable time. The manual specification value can include: manual pass, manual fail, null, unknown, and/or any other suitable value. For example, a reviewer at an entity can observe metadata associated with check values and assign a manual specification value to the specification based on the metadata. However, the manual specification value can be otherwise determined.

S460 can optionally include returning the specification value and/or manual specification value through an interface 130 (e.g., mobile application, web application, an API, etc.). The specification value and/or manual specification value is preferably returned to the entity (e.g., in association with the user identifier), but can additionally and/or alternatively be returned to the user (e.g., associated with the specification value), returned to a third-party (e.g., data provider), and/or be otherwise returned. However, the specification value and/or manual specification value can be otherwise returned.

S460 can optionally include storing the specification value and/or manual specification value in a database 140. The specification value and/or manual specification value is preferably stored in association with the user and/or user identifier, but can additionally and/or alternatively be stored in association with an entity identifier, a specification identifier, and/or any other identifier. The specification value and/or manual specification value can be stored for: lookup in the database 140, determination of a different specification value, and/or be otherwise reused. However, the specification value and/or manual specification value can be otherwise stored.

However, the user can be otherwise verified.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions, that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

One or more variations of the system and/or method can omit one or more of the above elements and/or include a plurality of one or more of the above elements in any suitable order or arrangement.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for identity verification, comprising:
receiving a first verification request from a first entity for a user;
determining a first specification associated with the first entity, wherein the first specification comprises a set of internal-level checks;
determining a set of internal-level check values for the set of internal-level checks using a set of trait instances associated with the user;
determining a first specification value for the first specification using the set of internal-level check values; and
determining a second specification value for a second specification associated with a second entity using a subset of the set of internal-level check values.

2. The method of claim 1, wherein each internal-level check of the set of internal-level checks is atomic.

3. The method of claim 1, further comprising providing the first specification value to the first entity in response to the first verification request, wherein the set of internal-level check values is hidden from the first entity.

4. The method of claim 1, wherein the set of internal-level checks is selected by the first entity on an interface.

5. The method of claim 1, wherein each internal-level check of the set comprises a set of traits, wherein each trait is associated with a set of trait parameter values, wherein determining the set of internal-level check values comprises:
determining the set of trait instances for the user that satisfies the set of trait parameter values for each trait of the set of traits; and
determining the set of internal-level check values for the set of internal-level checks based on the set of trait instances.

6. The method of claim 5, wherein a subset of trait instances of the set is determined by the user on an interface.

7. The method of claim 1, wherein the first specification comprises a set of external-level checks, the method further comprising: determining a set of external-level check values for each of the set of external-level checks based on the set of internal-level check values, wherein the first specification value is further determined based on the set of external-level check values.

8. The method of claim 1, wherein determining the second specification value for the second specification comprises:
receiving a second verification request from the second entity for the user;
determining the second specification associated with the second entity, wherein the second specification comprises a second set of internal-level checks, wherein the second set of internal-level checks overlaps with the first set of internal-level checks, wherein the subset of internal-level check values corresponds to the overlap; and
determining the second specification value for the second specification based on the subset of internal-level check values and values for a remainder of the second set of internal-level checks.

9. The method of claim 1, wherein the user is associated with a user identifier, wherein the set of internal-level check values is stored in association with the user identifier in a database, wherein the user identifier comprises at least one of an email, a phone number, or a biometric measurement.

10. The method of claim 1, wherein the first specification value comprises at least one of pass, fail, or manual review.

11. An identity verification system, comprising:
a processing system, configured to:
receive a first verification request from a first entity for a user;
determine a first specification associated with the first entity, wherein the first specification comprises a set of internal-level checks;
determine a set of internal-level check values for the set of internal-level checks using a set of trait instances associated with the user;
determine a first specification value for the first specification using the set of internal-level check values; and
determine a second specification value for a second specification associated with a second entity using a subset of the set of internal-level check values.

12. The system of claim 11, wherein the processing system is further configured to determine metadata based on the set of internal-level check values when the first specification value specifies manual review, wherein the metadata is provided to the first entity for manual review.

13. The system of claim 11, wherein each internal-level check of the set comprises a set of traits, wherein each trait is associated with a set of trait parameter values, wherein determining the set of internal-level check values comprises:
determining the set of trait instances for the user that satisfies the set of trait parameter values for each trait of the set of traits; and
determining the set of internal-level check values for the set of internal-level checks based on the set of trait instances.

14. The system of claim 13, wherein a subset of the set of trait instances is retrieved from a set of third-party data providers.

15. The system of claim 14, wherein determining the set of trait instances comprises sending a set of requests to the set of third-party data providers to retrieve the subset of trait instances.

16. The system of claim 13, wherein the set of trait instances is stored in a database, wherein a trait instance of the set is associated with a first instance timestamp and a third-party data provider, wherein the processing system is further configured to:
receive a new trait instance associated with a second instance timestamp and the third-party data provider; and
replace the trait instance of the set with the new trait instance in the database when the second instance timestamp is more recent than the first instance timestamp.

17. The system of claim 13, wherein the set of trait instances is stored in a database, wherein a trait instance of the set is associated with an expiration time, wherein the processing system is further configured to remove the trait instance from the database when the expiration time has passed.

18. The system of claim 11, wherein the set of internal-level check values is stored in a database, wherein determining the second specification value comprises retrieving the subset of internal-level check values from the database.

19. The system of claim 11, wherein the first specification comprises a set of external-level checks, wherein the processing system is further configured to: determine a set of external-level check values for each of the set of external-level checks based on the set of internal-level check values, wherein the first specification value is further determined based on the set of external-level check values.

20. The system of claim 19, wherein the processing system is further configured to:
determine an auxiliary external-level check not associated with the first specification;
determine an auxiliary external-level check value for the auxiliary external-level check; and
modify the first specification, wherein the set of external-level checks comprises the auxiliary external-level check, wherein the first specification value is further determined based on the auxiliary external-level check value.
